(19) United States
(12) Patent Application Publication
(10) Pub. No.: US 2010/0293081 A1
(43) Pub. Date: Nov. 18, 2010

(54) Device and method for reading, registering and analyzing data of automobile ECU

(76) Inventors: Jun Liu, Guangdong Province (CN); Fanghong Deng, Guangdong Province (CN); Yundong Lei, Guangdong Provice (CN); Gang Liu, Guangdong Province (CN)

Correspondence Address: BRIAN M. MCINNIS, 12th Floor, Ruttonjee House, 11 Duddell Street, Hong Kong, HK

(21) Appl. No.: 12/811,519

(22) PCT Filed: Aug. 19, 2008
(86) PCT No.: PCT/CN08/01487

§ 371 Date: Jul. 2, 2010

(30) Foreign Application Priority Data
Jan. 5, 2008 (CN) 200820001766.1
Jun. 2, 2008 (CN) 200810108331.1

(51) Int. Cl. G06F 7/00; G06F 12/02; G06F 13/14; G06Q 30/00

(52) U.S. Cl. 705/34; 711/103; 710/305; 701/33; 711/E12.008

(57) ABSTRACT

A device for reading and registering data of automobile ECU includes: a memory (11); a data processing unit (12) connected with the memory for processing collected data; a diagnosing interface circuit (13) communicatingly connected with the data processing unit and an automobile diagnosing pedestal and specially configured in accordance with automobile ECU protocol of various series of automobiles; a data communication interface (8) for communication between the device and an associated equipment thereof; a unit (14) for marking the occurring time to the registered data; a data reading and registering status indicating unit (10). The present invention also discloses a method for real-time reading and registering data of automobile ECU, an automobile diagnosing system and a diagnosing method. (FIG. 1)

### RELATED APPLICATIONS

This application is a co-pending application, which claims priority to PCT Application No. PCT/CN2008/001487 filed Aug. 19, 2008, which are herein incorporated by reference.

### FIELD OF THE INVENTION

The present invention relates to a device and method for reading, registering and analyzing data of automobile ECU (electric control unit).

### BACKGROUND OF THE INVENTION

An automobile ECU has a fault self-diagnosing function. When the ECU detects a fault signal, the fault signal is registered in a memory in a manner of fault code. The fault code can be transferred through a specific program and provided to a maintenance staff for analyzing fault position and reason. With the ECU becoming complicated increasingly, the automobile repair industry has more and more dependence and requirement to an ECU detector. A lot of code readers for automobile fault diagnosis, including a fault decoder for all kinds of automobiles and a fault code reading card for small type of automobile, are provided on the market. A conventional code reading card is not inserted in an automobile diagnosing pedestal for a long term. When a fault code and a freeze frame is required to read from an automobile ECU, the code reading card is inserted in the automobile diagnosing pedestal and then read out the default code and the freeze frame. If no fault exists, the conventional code reading card cannot read the fault code and the freeze frame.

However, with the widely use of automobile and increasing improvement of automobile performance, more and more automobile owners and automobile enthusiasts not only require to use a code reader for automobile fault diagnosis to read the automobile fault code for repairing the automobile when the automobile has fault, but also require to know the real-time operating status of the automobile for maintenance of the automobile. The automobile can be used and maintained more safely, more reliably and more economically, through knowing the real-time operating status of the automobile. Therefore, it is necessary to develop a device and method for real-time reading, registering and analyzing data of automobile ECU. An object of real-time knowing automobile operating status can be achieved through real-time monitoring and registering operating data of all parameters after the automobile is started.

### SUMMARY OF THE INVENTION

To meet the above-mentioned requirement, an object of the present invention is to provide a device and method for real-time reading, registering and analyzing data of automobile ECU.

To achieve the above object, in accordance with one aspect of the present invention, a device for reading and registering data of automobile ECU includes: a memory; a data processing unit connected with the memory for processing collected data; a diagnosing interface circuit communicatingly connected with the data processing unit and an automobile diagnosing pedestal and specially configured in accordance with automobile ECU protocol of various series of automobiles; a data communication interface for communication between the device and an associated equipment; a unit for marking the occurring time to the registered data; and a data reading and registering status indicating unit. The memory is an M25P16 type of flash memory. The data processing unit is a P89V51 type of singlechip including a CPU, an internal memory, and an I/O interface. The data communication interface includes a diagnosing interface for communicating the device and the automobile ECU, and a USB interface for communicating the device and a PC (personal computer). The unit for marking the occurring time to the registered data is a clock circuit, and the indicating unit is an LED. The device further includes a circulating storage control unit for replacing the foremost reading data registered in the memory with the newest reading data when the memory is full, which can be realized by employing a singlechip or any means known by one skilled in the art. As an alternative embodiment, the device further includes a transferring unit for real-time transferring the data stored in the memory to other unit. The device may further includes a monitoring unit for monitoring if the storing quantity of the memory reaches the given quantity, which can be realized by a singlechip or any means known by one skilled in the art; and a transferring unit for transferring the data stored in the memory to other unit when the storing quantity of the memory reaches the given quantity. The other unit is a PC or a network server. The transferring can be realized by a communication channel formed between the device and the other unit through any conventional manner. For example, the device is additionally disposed with a module such as GPRS or COMA, which can communicate with the other unit through communication network. Thus, the communication channel is set up between the device and the other unit and the transferring can be made through the communication channel. The device may is further includes a memory clear unit for deleting the transferred data after the data is transferred, which can be realized by a singlechip or other means known by one skilled in the art.

After the device is connected with an automobile diagnosing pedestal, the device runs the related diagnosing protocols thereof in turn to communicate with the connected automobile. The device enters data reading and registering status and registers the read data after communication is successful. The diagnosing protocols may be KWP, ISO, PWM, VPW or CAN-BUS according with the OBD II diagnosing standards. The power of the clock circuit of the device is supplied by a clock battery. When the device has not an external power supply, it still can work normally.

The clock circuit of the device marks the occurring time for the data registered by the device. When the device is connected with a PC, a user can configure the time of clock of the device to be consistent with the time of the PC through PC special software of the device for reading and registering data of automobile ECU. The indicating LED of the device indicates the working status of the device in a manner of twinkle. When the device detects the diagnosing protocol supported by the automobile, the twinkle times of the LED of the device are consistent with the running sequence number of the protocol in turn for showing which protocol is being attempted to communicate. When the automobile does not support the diagnosing protocol of the device, the LED lights constantly. After the device enters data registering status, the LED continuously and regularly twinkles. When communication is failed after the device enters the data registering status, the LED is turned off until the device enters data registering status again.

The device real-time reads and registers a certain quantity of related automobile operation data through connecting with the automobile diagnosing pedestal. Through a PC and a PC special software of the device for reading and registering data of automobile ECU, the owner of automobile can open the automobile operation related data registered by the device for reading and registering data of automobile ECU. The automobile operation status is fully shown by the registered data. At the same time, login the special website of the device for reading, registering and analyzing data of automobile ECU to online diagnose and get help from experts in the art through special software of the device for reading and registering data of automobile ECU. Thus, it facilitates the automobile owner to know his automobile fully, increases initiative of the automobile maintenance and repair, and increases safety and useful life of automobile. The device for reading and registering data of automobile ECU can real-time collect automobile engine data, real-time register the working status of the automobile during the automobile working. The automobile operation status is known fully through the registered data.

In accordance with a second aspect of the present invention, a method for reading and registering data of automobile ECU includes the following steps: connecting the device for reading and registering data of automobile ECU with an automobile diagnosing pedestal; the device running the related diagnosing protocols thereof in turn to communicate with the connected automobile after the automobile ignition switch is turned on; entering data reading and registering status and registering the read data after communication is successful.

Preferably, the diagnosing protocol is one of KWP, ISO, PWM, VPW and CAN-BUS according with the OBD II diagnosing standards.

The step of registering the read data includes storing the read data in a memory. Preferably, replace the foremost reading data stored in the memory with the newest reading data when the memory is full. As an alternative embodiment, the method further includes a step of real-time transferring the stored data or includes steps of monitoring if the storing quantity of the memory reaches the given quantity, and transferring the data stored in the memory to other unit when the storing quantity of the memory reaches the given quantity. Preferably, delete the transferred data after the data is transferred.

### BRIEF DESCRIPTION OF THE DRAWINGS

The technical solution and the beneficial effects of the present invention are best understood from the following detailed description with reference to the accompanying figures and embodiments.

FIG. 1 shows a diagram of the device for reading and registering data of automobile ECU in accordance with an embodiment of the present invention.

FIG. 2 is a perspective exploded view of the device for reading and registering data of automobile ECU in accordance with an embodiment of the present invention.

FIG. 3 is a flow chart of a method for reading and registering data of automobile ECU in accordance with an embodiment of the present invention.

FIG. 4 is a detailed flow chart of a method for reading and registering data of automobile ECU in accordance with an embodiment of the present invention.

FIG. 5 is a flow chart of a user uploading data in accordance with an embodiment of the present invention.

FIG. 6 is a flow chart of basic logic of auto reply in accordance with an embodiment of the present invention.

FIG. 7 is a flow chart of a user reading an analysis report in accordance with an embodiment of the present invention.

### DESCRIPTION OF THE PREFERRED EMBODIMENT

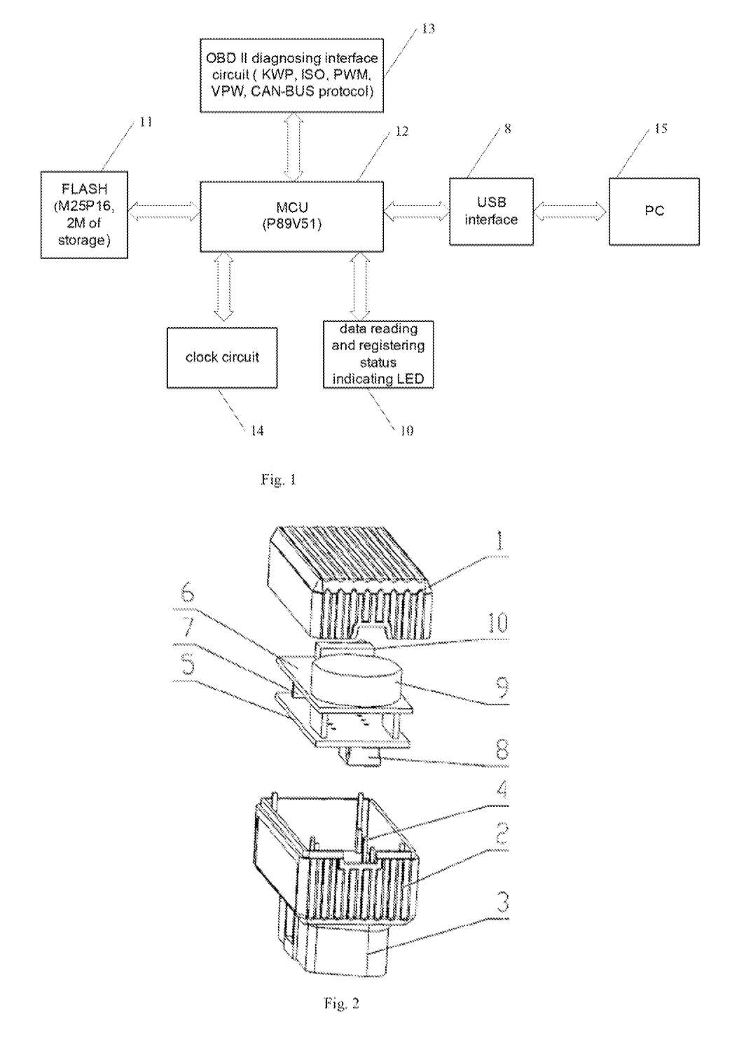

FIG. 1 shows a device for reading and registering data of automobile ECU in accordance with an embodiment of the present invention including a memory 11; a singlechip 12 electrically connected with the memory, employed as a core processing part of the device for reading and registering data of automobile ECU of the present invention, and including a CPU, an internal memory, and an I/O interface; a diagnosing interface circuit 13 communicatingly connected with the singlechip 12 and an automobile diagnosing pedestal; a diagnosing interface 3 used for data transmission between the diagnosing interface circuit and the automobile diagnosing pedestal; a USB interface 8 used for communication between the device and a PC; a clock circuit 14 used for marking the occurring date and time to the registered data; and a data reading and registering status indicating LED 10. The memory 11 of the device for reading and registering data of automobile ECU is an M25P16 type flash memory. The singlechip 12 of the device for reading and registering data of automobile ECU is a P89V51 type singlechip. The data communication interface 8 is a USB interface. The diagnosing interface circuit 13 of the device for reading and registering data of automobile ECU is specifically configured in accordance with ECU protocol of different series of automobile. The communication protocol is KWP, ISO, PWM, VPW, CAN-BUS and so on which meet the OBD II standard.

The device for reading and registering data of automobile ECU of the present invention is connected with the automobile diagnosing pedestal to communicate and register related data, through OBD II diagnosing interface circuit 13 and the automobile diagnosing interface 3. Working power (5V) is obtained through stabilizing voltage of storage battery (12V) of the automobile diagnosing pedestal. The data reading and registering status indicating LED 10 is used to indicate the communication status during the communication between the device and the automobile diagnosing pedestal. In addition, the singlechip 12 being the P89V51 type singlechip is electrically connected with the memory 11. The memory 11 being the M25P16 type flash memory has 2 M of storage and can register 32 groups of automobile operation data. The device has a clock battery 9 and the clock circuit 14 to which the clock battery 9 supplies power. When the device for reading and registering data of automobile ECU is not connected with an external power supply, the clock circuit 14 can work normally. The clock circuit marks detailed occurring date and time for the data registered by the device. When the device is linked with the PC 15, a user can configure the time of the clock of the device to be consistent with that of the PC 15, that is to be consistent with the standard time of the user's locus, through a PC special software installed at the device for reading and registering data of automobile ECU, thereby ensuring registering time of data is consistent with the standard time of the user's locus for precisely knowing the occurring time of the related registering data. When the device is linked with the PC 15, the user can delete history registering data through a command of the PC special software installed at the device for reading and registering data of automobile ECU. If the history registering data is not deleted, when the data registered in the flash memory is over 32 groups, new registering data will overwrite the history registering data in turn. However, there is a shortcoming for not deleting history registering data. That is, when the data is over 32 groups, only the newest 32 groups of data is registered, and the data earlier than the newest 32 groups of data is overwritten whereby the former information cannot be known. To overcome the shortcoming, a monitoring unit and a transferring unit is provided. The monitoring unit is used to monitor if the quantity of the registering data reaches a given quantity (may less than or equal to 32 groups). If the quantity of the registering data reaches the given quantity, the transferring unit transfers the registering data to other mass storage unit through transferring mechanism, whereby the user can know more data. The mass storage unit may be a PC or a network server. The registering data can be transferred from the device to the network server through wireless communication. The registering data can be real-time transferred from the device to the network server. After transferring, a memory clear unit can be employed to clear the transferred data. The memory clear unit may be a singlechip or other conventional means for realizing the function.

FIG. 2 shows a perspective exploded view of the device for reading and registering data of automobile ECU in accordance with the embodiment of the present invention. The device includes an upper cover 1 and a lower cover 2. The automobile diagnosing interface 3 is connected with the automobile diagnosing pedestal in use. The automobile diagnosing interface 3 and the lower cover 2 are connected as a whole. The automobile diagnosing interface 3 is disposed with a plurality of automobile diagnosing interface pins 4. The device for reading and registering data of automobile ECU is connected with the automobile diagnosing pedestal in use via the automobile diagnosing interface pins 4. The structure and size of the automobile diagnosing interface 3 and the size, the structure and the quantity of the automobile diagnosing interface pins 4 are specially configured in accordance with ECU protocols of different series of automobiles. The automobile diagnosing interface pins 4 are connected with a first circuit board 5. The communication USB interface 8 is connected with the first circuit board 5. A user can connect the device with the PC 15 via the communication USB interface 8 and read or clear the registering data through the special PC software of the device for reading and registering data of automobile ECU. The clock battery 9 and the data reading and registering is status indicating LED 10 are disposed at a second circuit board 6. The second circuit board 6 is connected with the first circuit board 5 via a plurality of solder pins. The first and second circuit boards 5, 6 are the core parts of the device for reading and registering data of automobile ECU.

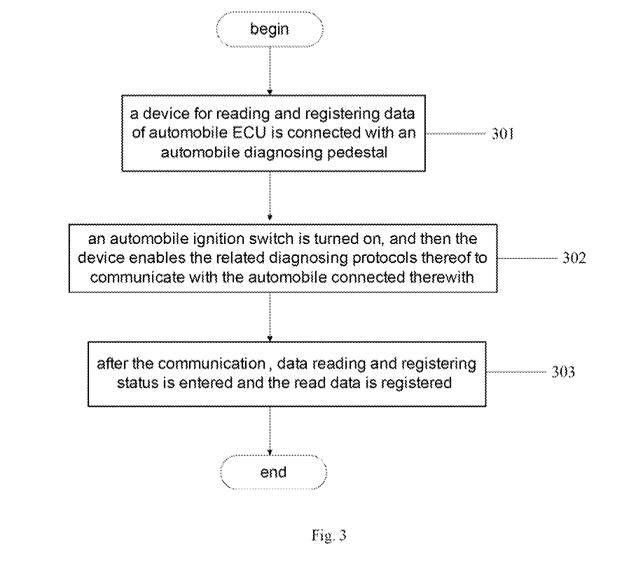

FIG. 3 shows a flow chart of a method for reading and registering data of automobile ECU. After the method is begun, at step 301, a device for reading and registering data of automobile ECU is connected with an automobile diagnosing pedestal. At step 302, an automobile ignition switch is turned on, and then the device enables the related diagnosing protocols thereof to communicate with the automobile connected therewith. At step 303, after the communication, data reading and registering status is entered and the read data is registered, and then the method is ended.

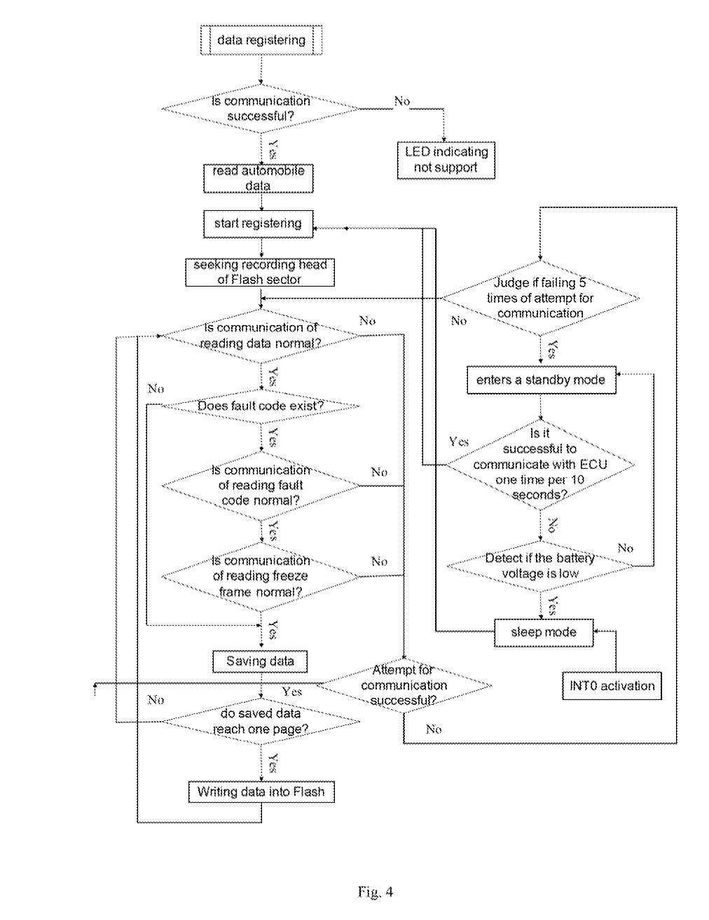

FIG. 4 shows a flow chart of using the device for reading and registering data of automobile ECU of the present invention to read and register the data of automobile ECU. Firstly, the device for reading and registering data of automobile ECU is inserted to the automobile diagnosing pedestal. After the automobile ignition switch is turned on, the automobile diagnosing pedestal supplies working power to the device for reading and registering data of automobile ECU, and the device enables the related diagnosing protocols thereof to communicate with the automobile connected therewith in turn. In this embodiment, the device for reading and registering data of automobile ECU supports OBD II diagnosing standard, and in a predetermined manner and in turn runs five communication protocols including KWP, ISO, PWM, VPW, and CAN-BUS. At this moment, the twinkle times of the data reading and registering status indicating LED 10 are consistent with the running sequence number of the protocol for showing the type of the protocol attempted to communicate in turn. For example, the running sequence number of the PWM protocol attempted to communicate is 3, the twinkle times of the data reading and registering status indicating LED 10 is 3. After continuous attempt to run 3 communication protocols in turn for communication, if the diagnosed automobile does not support any of the protocols, the data reading and registering status indicating LED 10 lights constantly after finishing attempt to run the protocols, which means the device does not support the diagnosed automobile and cannot register the related data. If the data reading and registering status indicating LED starts to continuously and regularly twinkle, which means the communication is successful, the device starts to read automobile data and register the diagnosed automobile data. The diagnosed automobile data includes automobile operation data, fault code and freeze frame when the automobile has fault code. If the device fails to communicate to an automobile ECU some time for cause during registering data, which results in disconnection, the device for reading and registering data of automobile ECU will continue to attempt to communicate with the automobile ECU. If failing after 5 times of attempt for communication, the device enters a standby power saving mode. After that, the device attempts to communicate with the automobile one time per 10 seconds and detect the automobile battery voltage. When the automobile battery voltage is at a normal status, the device continues to be at the standby power saving mode and attempt to communicate with the automobile one time per 10 seconds and detect the automobile battery voltage. When the automobile battery voltage is at a low voltage status, the device stops to attempt to communicate with the automobile. The device fails to communicate to an automobile ECU for cause during reading and registering data, the data reading and registering indicating LED 10 is turned off. When the device enters the data reading and registering status again, the data reading and registering status indicating LED 10 continuously and regularly twinkles again. After a user has the automobile related data and fault code through the device for reading and registering data of automobile ECU, if the user want to know the data registered at the device for reading and registering data of automobile ECU, the user can turn off the automobile ignition switch, pull out the device for reading and registering data of automobile ECU, connect with the PC 15 via a USB cable attached with the device, and run the special PC software of the device for reading and registering data of automobile ECU. The user firstly displays the registered related data and fault code via client end software, and then can detailedly read the registered data and dynamic change through Report, Trip information, Data and Graph. A preliminary diagnosing report can be obtained through diagnosing and analyzing the registered main data. The related data may be uploaded to a professional website for online diagnosing. The user can visit a special website (www.crecorder.com), register, ask for help from the experts in this field through online service and then get the help from the experts.

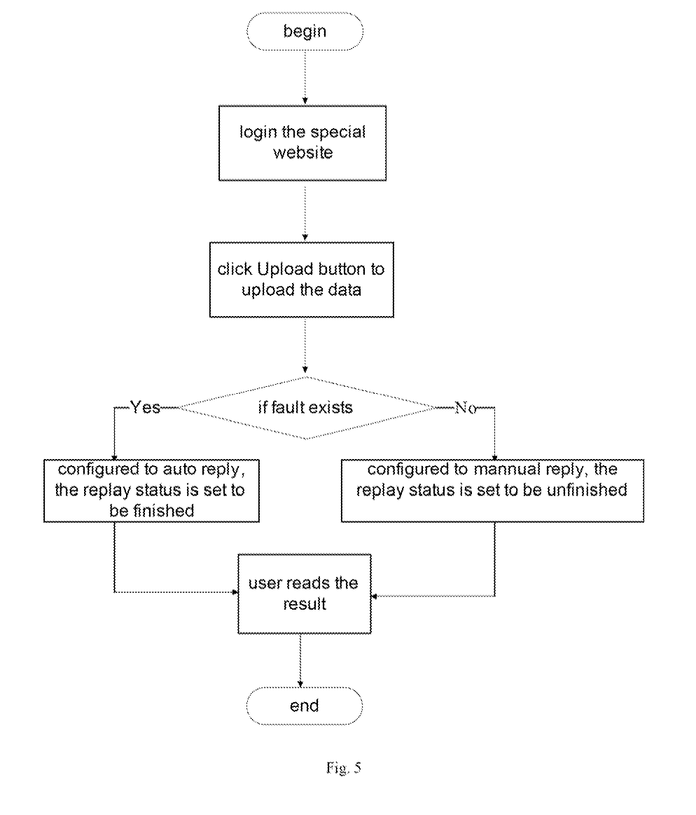

FIG. 5 shows a flow chart of a user uploading data. After flow starts, the user uploads data through special website (www.crecorder.com). The user logins the special website and then clicks Upload button to upload the data to the back-stage system. Then according to judgment if fault exists, function of user visiting and reading report is configured to auto reply or manual reply. The auto reply has two manners that are auto reply with fault code and auto reply without fault code. When the auto reply is without fault code, the reply content is made according to numerical value of data and relationship thereof. Then, the user reads the result and the flow is over.

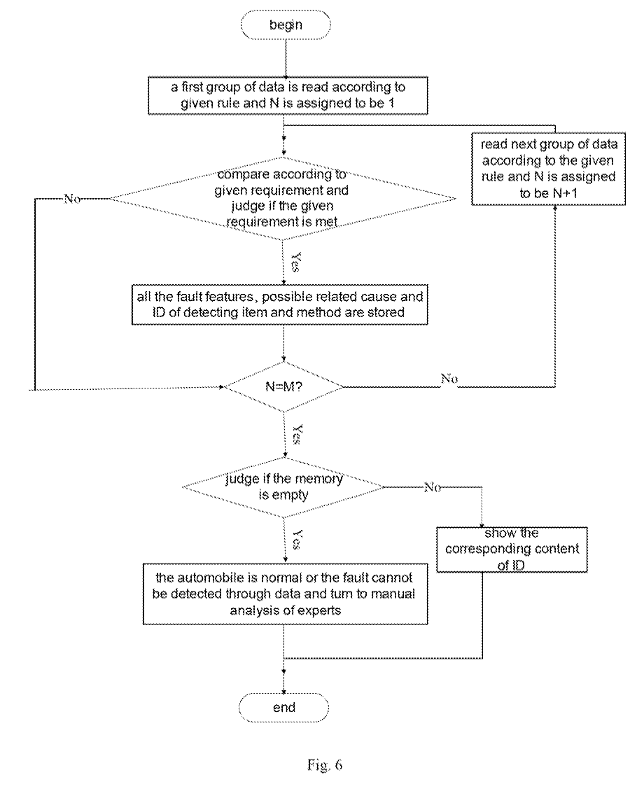

FIG. 6 shows a flow chart of basic logic of auto reply, wherein N is recurring number, M is given fault feature number, that is, data group number, such as 16. After the flow starts, a first group of data is read according to given rule and N is assigned to be 1. Then compare according to given requirement and judge if the given requirement is met. If yes, all the fault features, possible related cause and ID of detecting item and method are stored. Then judge if N equals M. If N is less than M, which means that operation to M data groups is not finished, read next group of data according to the given rule and N is assigned to be N+1. Then go to the judgment step of comparing according to given requirement and judging if the given requirement is met. If N equals to M, which means that operation to M data groups is finished, judge if the memory is empty. If empty, it means the automobile is normal or the fault cannot be detected through data and turn to manual analysis of experts. If not empty, show the corresponding content of ID and the flow is ended.

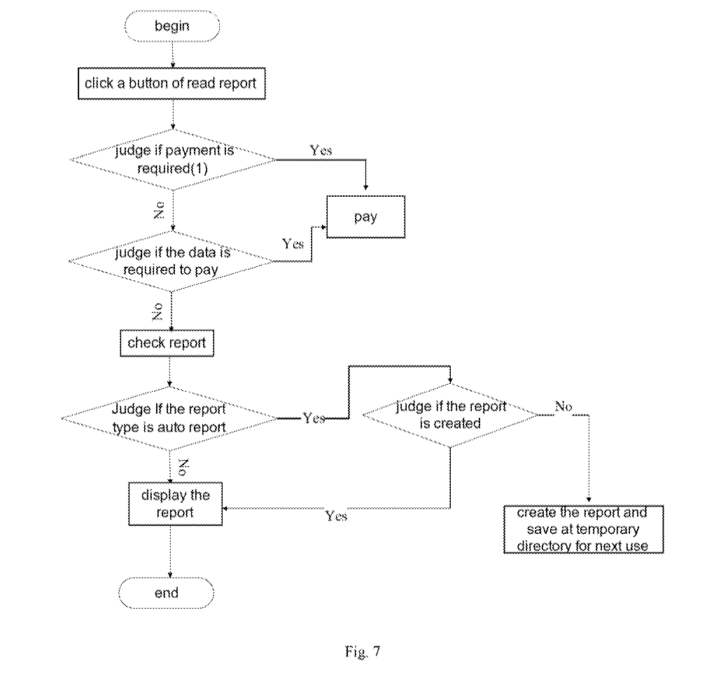

FIG. 7 shows a flow chart of a user reading analysis report. After the flow starts, click a button of read report and judge if payment is required. The judgment is similar to a master switch of charging system. If the judging result is that payment is not required, further judge if the data is required to pay (experts can set up if the data is charged. Default is to charge. However, if the user data indicates that the automobile is no problem, it can be set up to be no charge.). If no payment for the data is required, directly go to check report. If payment for the data is required, go to payment step. After payment is finished, go to check report. After checking report, further judge type of report. If the report type is manual report, display the report and then the flow is ended. If the report type is auto report, further judge if the report is created. If the report is created, display the report and then the flow is ended. If the report is not created, create the report and save at temporary directory for next use (the auto reply document is created when the user checks report, and the created report is saved at temporary directory for a period of time, and so it does not need create report when the user checks report later for increasing check speed.), and then display the report, and the flow is ended.

The user can upload report, and also can online search fault code.

1.Quick search of fault code (free).

A user directly inputs the required fault code at the website, system auto replies simple fault code definition. For example, input DTC: P0201. System auto replies: Injector Circuit/Open-Cylinder 1.

2. Fault code search according to automobile series (free).

1) Select automobile series, such as MARKER: FORD.

2) Select age, such as YEAR;2005.

3) Input fault code and get definition description, such as DTC;P0013 Camshaft Position Actuator B-Bank 1 Circuit Malfunction.

Search of fault code/data may be charged. Payment mode may be classified as charge based on given times, charge based on each time, and charge based on a fixed period. For example, charge based on given times means to charge a certain fee for checking a certain times of reply, such as USD5 for checking 3 times of reply, USD8 for checking 7 times of reply. Charge based on each time means to charge a certain fee for checking one time of reply, such as USD2 for one time of reply. Charge based on a fixed period means to charge a certain fee for a given period of time, such as USD20 for one month of auto reply, USD30 for one month expert reply.

The following is to detailedly describe CRecorder professional website (www.crecorder.com). CRecorder website includes three parts: common user function, expert management, and CRecorder back-stage management.

1. Common user function

Open IE and input www.crecorder.com in address bar for visiting the website. At the front page, a user can see the following navigation tags: Home, Product introduction, Frequent asked question (FAQ), Help, and Contact us.

1) At Product introduction pages, the user can see introduction of CRecorder products, product pictures and product software related pictures.

2) At FAQ pages, the user can see a lot of operation questions related to CRecorder products and purchase manners of products. The FAQ will be updated continuously.

3) At Help pages, the user can see user manual of products, driver installation steps and so on.

4) At Contact us pages, contact information of company including telephone number, fax number and Email address, is shown.

At the top left corner of the front page of the website is the login bar of user login, register, and retrieve password.

1) Click register button to enter the register page for registering as a member. Registering code is sent along with CRecorder products purchased by the user and is required for register. The user can register according to the register hint. The register information is more detailed, the high quality service to the user is more.

2) Login user interface after register.

3) If the user forgets user password, the user can click password forgetting link and then input user ID in the linked page. The system will send the user password to the mailbox registered by the user.

4) After login, a navigation bar is displayed at the left side. User information interface is firstly shown. The user information interface displays main register information of user. The user can configure if to receive system email through the user information interface.

5) Download center. Download center page displays newest CRecorder software version, issue date and update information of the former version. The user can download user manual and CRecorder software through the download center.

6) Data uploading. The user can upload information collected by CRecorder software to the website for expert analysis through clicking upload button in the data uploading page.

7) My question. The my question page displays questions and documents uploaded by the user. If expert replies the user questions, the user can click check button to get solution. If the check button is shown at unactivated state (gray), the user question is not replied temporarily. Be patient to wait. The user can download the document uploaded to website by himself.

8) Password change. The user is permitted to change his password through the password change page. The old password must be provided correctly when the password is changed.

9) Complaint collection. The user can submit some complaint and suggestion to CRecorder products through the complaint collection page.

10) Fault code search. The user can input fault code in the fault code search page to get corresponding explanation.

11) Interact message.

12) Safe Quit. Click the safe quit button to logout.

2. Expert management function

1) Open IE and input www.crecorder.com/expert in address bar for visiting expert management page. Input user ID and password to login.

2) After login, a navigation bar which shows main functions of the managing system is shown at the left side.

3) Member information. Registered information of experts is displayed in the member information page.

4) Password change. The user is permitted to change his password through the password change page. The old password must be provided correctly when the password is changed.

5) Unsettled question. The documents (not replied) uploaded by common users and including fault codes of various series of automobile are displayed. Click edit button to reply and click download button to download the document uploaded by the user.

6) Settled question. The documents (replied) uploaded by common users and including fault codes of various series of automobile are displayed. Click check button to read the created solution and edit report to reply renewedly. Click download button to download the document uploaded by the user.

7) All question. The documents (replied and not replied) uploaded by common users. Experts can configure search term to search in the all question page for rapidly getting the searched question.

8) Software download. Software download page displays the newest CRecorder software version, issue date and update information of the former version. The user can download user manual and CRecorder software through the software download page.

9) Safe quit. Click the safe quit button to logout.

3. Back-stage management function

1) Open IE and input www.crecorder.com/admin in address bar for visiting back-stage management page. Input user ID and password to login.

2) Navigation bar showing the main functions of the manage system is displayed at the left side.

3) Data management. The data management page provides functions of checking the reply of experts to questions of user, downloading fault code document uploaded by the users, and searching in accordance with input data sequence number.

4) Product information keyin. The back-stage administrator can click add button to keyin product serial number/register code, click delete button to delete selected serial number/fault code, and click export button to export a period of serial number/fault code information through the product information keyin page.

5) Order management. The back-stage administrator can check related information of order through the order management page. The order management supports search function.

6) Nation management. The back-stage administrator can check related information of national currency, click add button to add related national information, and click delete button to delete related national information through the nation management page.

7) Price management. The back-stage administrator can check price of the CRecorder software at each country through the Price management page. The price management supports functions of adding, deleting and searching.

8) Language management. The back-stage administrator can check language supported by software through the language management page.

9) User information management. The back-stage administrator can check the registered information of common users through the user information management page.

10) Expert information management. The expert information management can check the registered information of experts through the expert information management page.

11) Administrator information management. The back-stage administrator can check information of administrator, and authorize the administrator. Of cause, the authority of user should be high enough.

12) System function. The back-stage administrator can check the back-stage detailed function through the system function page. The system function supports functions of adding and deleting.

13) Product management. The back-stage administrator can check a series of product information with the user information of the product listed through the product management page. The product management supports many searching terms (such as term of serial number/register code, or term of user).

14) Visitor calculation. The back-stage administrator can check visiting quantity of the website at a certain period through the visitor calculation page.

15) Mass email. The back-stage administrator can mass email through the mass email page.

16) Complaint management. The back-stage administrator can accept and handle user complaint through the complaint management page.

17) Fault code management. The back-stage administrator can define the fault code and operation manner through the fault code management page. The fault code management supports functions of adding, deleting and searching.

It is noted that all functions of the back-stage management are not listed. It depends on the authority of each ID. The above description only covers some possible content of the website. One skilled on the art can add, amend, or delete the above description according to actual demands.

In accordance with the above description, in one aspect, the present invention provides an automobile diagnosing system including: the device for reading and registering data of automobile ECU; and a tool for analyzing the data read and registered by the device. The tool may be a special analyzing module, such as special software, hardware and firmware which can analyze, for diagnosing and analyzing the registered data to obtain a preliminary diagnosing report. The tool may includes an online analysis system which includes an upload module for uploading the read and registered data to the website, and an auto analysis and reply module for analyzing the data uploaded to the website. As an alternative embodiment, the online analysis system includes an upload module for uploading the read and registered data to the website, and an expert analysis module for analyzing the data uploaded to the website. The online analysis system further includes a billing module for billing for the service.

In another aspect, the present invention provides an automobile diagnosing method including the following steps: employing the device for reading and registering data of automobile ECU to read and register data; and analyzing the registered data. The step of analyzing the registered data includes the following steps: uploading the registered data to the website; auto analyzing the data and auto replying. As an alternative embodiment, the step of analyzing the registered data includes the following steps: uploading the registered data to the website; and analyzing the data and replying through expert system. In addition, after analyzing the data, a step of billing for the analysis is provided. The steps of uploading, analyzing and replying are real-time. The step of billing is also real-time.

As described above, the device for reading and registering data of automobile ECU of the present invention real-time registers related data of various systems after automobile starts, and automobile fault code in a certain period of time, and continuously updates related information, through the automobile diagnosing pedestal. The user can download data and fault code special analysis software from the website associated with the device to a user's PC. Through connecting the communication USB interface of the device for reading and registering data of automobile ECU with the users PC, review the registered data through the data and fault code special analysis software, thereby detailedly observing the registered data and fault code, fully reading and registering the automobile operation status through the PC. At the same time, login the special website through special software to online diagnose for having help from expert in the art. Thus, it facilitates the automobile owner to know his automobile fully, increases initiative of the automobile maintenance and repair, and increases safety and useful life of automobile. At the same time, it effectively reduces the adverse affect to the automobile owner due to asymmetric information.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A device for reading and registering data of automobile ECU comprising:
a memory;
a data processing unit connected with the memory for processing collected data;
a diagnosing interface circuit communicatingly connected with the data processing unit and an automobile diagnosing pedestal and specially configured in accordance with automobile ECU protocol of various series of automobiles;
a data communication interface for communication between the device and an associated equipment;
a unit for marking the occurring time to the registered data;
a data reading and registering status indicating unit.

2. The device of claim 1, wherein the memory is an M25P16 type of flash memory.

3. The device of claim 1, wherein the data processing unit is a singlechip.

4. The device of claim 3, wherein the singlechip includes a CPU, an internal memory, and an I/O interface.

5. The device of claim 3 or 4, wherein the singlechip is a P89V51 type of singlechip.

6. The device of claim 1, wherein the data communication interface includes a diagnosing interface for communicating the device and the automobile ECU, and a USB interface for communicating the device and a PC.

7. The device of claim 1, wherein the unit for marking the occurring time to the registered data is a clock circuit, and the indicating unit is an LED.

8. The device of claim 1, further comprising a circulating storage control unit for replacing the foremost reading data registered in the memory with the newest reading data when the memory is full.

9. The device of claim 1, further comprising a transferring unit for real-time transferring the data stored in the memory to other unit.

10. The device of claim 1, further comprising a monitoring unit for monitoring if the storing quantity of the memory reaches the given quantity;
and a transferring unit for transferring the data stored in the memory to other unit when the storing quantity of the memory reaches the given quantity.

11. The device of claim 9 or 10, wherein the other unit is a PC or a network server.

12. The device of claim 9 or 10, further comprising a memory clearing unit for deleting the transferred data after the data is transferred.

13. A method for reading and registering data of automobile ECU including the following steps:
connecting the device for reading and registering data of automobile ECU of claim 1 with an automobile diagnosing pedestal;
the device running the related diagnosing protocols thereof in turn to communicate with the connected automobile after the automobile ignition switch is turned on;
entering data reading and registering status and registering the read data after communication is successful.

14. The method of claim 13, wherein the diagnosing protocol is one of KWP, ISO, PWM, VPW and CAN-BUS according with the OBD II diagnosing standards.

15. The method of claim 13, wherein the step of registering the read data includes storing the read data in a memory.

16. The method of claim 15, further comprising the following step: replacing the foremost reading data stored in the memory with the newest reading data when the memory is full.

17. The method of claim 15, further comprising the following step: real-time transferring the data stored in the memory to other unit.

18. The method of claim 15, further comprising the following steps:
monitoring if the storing quantity of the memory reaches the given quantity;
transferring the data stored in the memory to other unit when the storing quantity of the memory reaches the given quantity.

19. The method of claim 17 or 18, further comprising the following step:
deleting the transferred data after the data is transferred.

20. An automobile diagnosing system comprising:
the device for reading and registering data of automobile ECU of claim 1, and a tool for analyzing the data read and registered by the device.

21. The system of claim 20, wherein the tool is a special analysis module, including software, hardware and firmware, for diagnosing and analyzing the registered data to obtain a preliminary diagnosing report.

22. The system of claim 21, wherein the tool further includes an online analysis system.

23. The system of claim 22, wherein the online analysis system includes:
an uploading module for uploading the read and registered data to a website; and
an auto analysis and reply module for analyzing the data uploaded to the website.

24. The system of claim 22, wherein the online analysis system includes:
an uploading module for uploading the read and registered data to a website; and
an expert analysis module for analyzing the data uploaded to the website.

25. The system of claim 23 or 24, wherein the online analysis system further includes a billing module for billing for the service.

26. An automobile diagnosing method comprising the following steps:
reading and registering data through the device for reading and registering data of automobile ECU of claim 1;
analyzing the registered data.

27. The method of claim 26, wherein the step, of analyzing the registered data includes:
uploading the registered data to a website; and
auto analyzing the data and replying.

28. The method of claim 26, wherein the step of analyzing the registered data includes:
uploading the registered data to a website; and
analyzing the data and replying through an expert system.

29. The method of claim 27 or 28, further comprising a step of billing for the analysis after analyzing the data.

30. The method of claim 27 or 28, wherein the steps of uploading, analyzing and replying are real-time.

31. The method of claim 29, wherein the steps of billing is real-time.
